(19) United States
(12) Patent Application Publication
(10) Pub. No.: US 2009/0273215 A1
(43) Pub. Date: Nov. 5, 2009

(54) SAFETY SEAT FOR INSTALLING A BABY OR A VERY YOUNG CHILD ON A VEHICLE SEAT

(75) Inventors: Derrick Barker, Worcestershire (GB); Benoit Cousin, Les Clayes Sous Bois (FR)

Correspondence Address: MCCORMICK, PAULDING & HUBER LLP, CITY PLACE II, 185 ASYLUM STREET, HARTFORD, CT, 06103, US

(73) Assignee: EQUIPBABY (UK) LIMITED, Windsor, Berkshire (GB)

(21) Appl. No.: 12/063,809

(22) PCT Filed: Aug. 10, 2006
(86) PCT No.: PCT/FR2006/001938

§ 371 Date: Jul. 16, 2009

(30) Foreign Application Priority Data
Aug. 17, 2005 (FR) 0508575

(51) Int. Cl. B60N 2/28; A47D 1/10; B60N 2/26

(52) U.S. Cl. 297/253

(57) ABSTRACT

The invention relates to a safety seat for installing a baby or a very young child on a vehicle seat, the safety seat comprising a seat structure and an intermediate structure (50) providing the connection between the seat structure and a standard anchor unit associated with the vehicle seat, said intermediate structure being made up of a first structure (100) and a second structure (200). In accordance with the invention, direct and separable snap-fastening engagement means are side lugs (52) hinged about a common axis (53) and the first structure has side branches (101) that form rails on which slides of the second structure (200) are mounted, which slides are interconnected by a crossbar. In addition, each side branch (101) presents a ratchet of catches that co-operate with a pawl carried by an associated slide, the catches of said ratchets defining a plurality of axial positions in which the second structure (200) can be locked.

### CROSS REFERENCE TO RELATED APPLICATIONS

This application is entitled to the benefit of and incorporates by reference essential subject matter disclosed in International Patent Application No. PCT/FR2006/001938 filed on Aug. 10, 2006 and French Patent Application No. 0508575 filed Aug. 17, 2005.

### FIELD OF THE INVENTION

The present invention relates to a safety seat for installing a baby or a very young child on a vehicle seat.

### BACKGROUND OF THE INVENTION

Very numerous arrangements have already been proposed for safety seats that enable a child to be installed on a vehicle seat, such safety seats generally comprising a seat structure for resting on a seat cushion of a vehicle and for bearing against a seat back of said vehicle, either with fastening being provided by the rear seat belt (see for example document EP 1 418 085 A1), or else with fastener means engaging an anchor unit associated with the vehicle seat (e.g. a so-called “isofix” unit in accordance with the existing European standard).

In a first approach, proposals have been made to equip the seat structure with side bars that terminate in end hooks arranged to be capable of hooking in hinged manner on an anchor unit of a vehicle. Under such circumstances, the hooking bars are rigidly secured to the seat structure so that when the seat structure is put into place for hooking onto the anchor unit, it is in the form of a single block.

To illustrate that approach, reference can be made to documents EP 1 369 293 A1, EP 0 976 607 A1, EP 0 952 032 A2, U.S. Pat. No. 5,487,588, DE 197 23 345 C1, DE 197 08 044 C1, and DE 295 06 847 U1.

Thus, in that approach, the seat structure, when it is in place and hooked to the anchor unit, can pivot only about the axis associated with the anchor unit and extending across the vehicle, which axis is generally located behind the seat cushion and at the bottom of the seat back. Freedom to pivot about the axis is naturally limited, insofar as such pivoting causes the seat cushion of the vehicle to be flattened.

The main drawback of arrangements in accordance with that first approach lies in the difficulty of putting the seat structure into place, insofar as it is not easy to see clearly the end hooks that are to hook onto two laterally spaced-apart points of the vehicle anchor unit, since the bottom and rear faces of the seat structure mask the end hooks to a large extent. That runs the risk of hooking being faulty, and in particular the risk of only one end hook being hooked onto a rod of the anchor unit, while the other end hook is not hooked. It is easy to understand that such faulty hooking completely negates the safety expected when a child is placed on the seat and the vehicle is in motion.

In a second approach, proposals are made for an intermediate structure that provides the connection between the seat structure and the standard anchor unit associated with the vehicle seat.

One such approach is illustrated for example in document U.S. Pat. No. 5,816,651, which teaches connecting the raisable armrest of the seat structure to the standard anchor unit via hinged struts. That arrangement presents the advantage of making it easier to put the seat structure into place insofar as the field of view for putting the seat structure into place is improved when the armrests are raised, with the armrests then being lowered only once it is certain that hooking has been achieved correctly on two points of the anchor unit. When the armrests are lowered, the bottom and rear faces of the seat structure are in contact with the seat cushion and the seat back of the vehicle. Nevertheless, the drawback of that structure lies in the need to provide armrests that can be raised by being pivoted. In addition, it is not possible to turn the seat structure around so as to orient it not facing forwards, but facing backwards, thereby making it possible to install a baby on said seat.

The same approach is also illustrated by document EP 1 090 804 B1 in which provision is made for an intermediate structure providing the connection between the seat structure and the standard anchor unit associated with the vehicle seat, which intermediate structure is made up of two rigid L-shaped bars, each bar having a horizontal branch with its end hooked to the anchor unit, and a branch that is vertical (or slightly oblique) having its end hinged to the seat structure, while remaining associated with said structure. With such an arrangement, the seat structure can then move relative to the vehicle seat, being capable of turning about two transverse pivot axes, the first axis being at the anchor unit, i.e. level with the support surface of the seat cushion, and the second axis being raised significantly above said support surface, being level with the bearing surface of the seat back. It should be observed that the intermediate structure is permanently connected to the seat structure. The drawback of that arrangement lies again in the restricted field of view, making it difficult to put the seat structure into place and difficult to be sure that it is properly hooked to the standard anchor unit at two points. According to the teaching of that document, this drawback is compensated by better behavior in the event of the vehicle suffering a front impact, the two above-mentioned hinge axes leading to the seat cushion being flattened in a direction perpendicular to its support surface. Furthermore, as in the preceding arrangement, that intermediate structure arrangement with L-shaped bars allows the seat structure to be put into place only facing forwards.

Still with the same approach, other intermediate structure arrangements have been proposed that, unlike the arrangement of above-mentioned document EP 1 090 804 B1, allow the seat to be mounted facing forwards or facing backwards, however said intermediate structure continues to be permanently connected to the seat structure, with the drawbacks that stem therefrom, as mentioned above (see for example documents DE 196 46 621 C1 and EP-A-1 151 893).

Document DE 199 46 579 A1, which illustrates the state of the art closest to the invention, teaches a safety seat for installing a baby or a very young child on a vehicle seat, the safety seat comprising both a seat structure for resting on a seat cushion of a vehicle and for bearing against a seat back of said vehicle, and an intermediate structure for providing the connection between the seat structure and a standard anchor unit associated with the vehicle seat, said intermediate structure being an independent structure that is itself made up both of a first structure comprising, on either side of a vertical plane of symmetry, two parallel side branches terminating in end hooks arranged to be capable of hooking in hinged manner on a standard anchor unit of a vehicle, and of a second structure mounted to slide on the side branches of the first structure, being capable of being locked thereon in a plurality of axial positions, said second structure including, on either side of said plane of symmetry, elements arranged to enable direct or separable snap-fastening engagement of two fastener tabs that are secured to the seat structure.

In above-mentioned document DE 199 46 579 A1, the independent intermediate structure is designed to solve a problem of adapting to different widths, the adapter as constituted in that way enabling a seat to be secured having fastener tabs that are spaced apart by a distance that is different from the spacing between the anchor points of the vehicle seat. It should be observed that the length of the side branches of that intermediate structure is adjusted once and forever in order to match the safety seat to the depth of the seat cushions of the vehicle back seat concerned. Furthermore, the direct and separable engagement elements are arranged to receive fastener tabs provided at the ends of safety belts associated with the seat.

With such a structure, it is not easy to put the safety seat into place, and it can be put into place facing forwards only.

### BRIEF SUMMARY OF THE INVENTION

An object of the present invention is to devise a safety seat capable of installing a baby or a very young child on a vehicle seat, and of a structure that enables it to be put into place easily, while guaranteeing it is properly hooked to a standard anchor unit associated with the vehicle seat, and that provides completely reliable rigidity once the seat structure has been put into place.

Another object of the invention is to devise a safety seat arranged to enable it to be fastened to a standard anchor unit equally well facing forwards and facing backwards, so as to make it possible to install a very young child (in the forward-facing position known as “group 1”) or a baby (in the backward-facing position known as “group 0”).

The above-specified problem is solved in accordance with the invention by a safety seat of the above-specified type, in which the elements for direct and separable snap-fastening engagement of the fastener tabs associated with the seat structure are side lugs hinged about a common transverse axis, and in which one of the first structure and the second structure presents two parallel ratchets of catches with which respective pawls co-operate that are urged against said ratchets by respective associated resilient members, said pawls being carried by the other one of said first structure and of said second structure, the mutual engagement direction corresponding to the second structure moving towards the end hooks of the side branches of the first structure, and the catches of said ratchets define the plurality of axial positions for locking the second structure on said side branches of the first structure.

Thus, the above-specified intermediate structure, which constitutes an independent structure, can be put into place on its own initially, independently of the seat structure, and this can be done very easily, with it being completely certain that it hooks correctly on the standard anchor unit, after which the seat unit is engaged on the side lugs which are still far away from the seat back, thus presenting a field of view that is good for this operation and making it possible to be sure that both fastener tabs of the seat structure are properly engaged, after which it suffices to push on the seat structure as put into place on the side lugs, in a direction parallel to the support surface of the seat cushion, until it comes into contact with the bearing surface of the seat back, the engagement of the second structure on the first structure serving to provide locking in the final position both automatically and completely reliably.

This is thus the first time it has been possible to propose an independent structure that is completely independent and that considerably simplifies putting the seat structure into place or removing it. It should be observed that the two hinge axes (the transverse axis of the standard anchor unit and the pivot axis of the side lugs) are both level with the support surface of the seat cushion of the vehicle, thus providing a hinge structure that is very different from the structure of above-mentioned document EP 1 090 804 B1 in which both pivot axes are offset upwards.

According to a particularly advantageous characteristic of the invention, the first structure is generally U-shaped with side branches forming rails on which slides of the second structure are mounted, the slides being interconnected by a crossbar on the axis common to the two side lugs of said second structure.

It is then possible to provide for the ratchets of catches to be carried by the side branches of the first structure, and for the pawls associated with said ratchets to be carried by the slides of the second structure.

Also advantageously, the side branches of the first structure include oblong slots through which the crossbar of the second structure passes, said slots thus defining a sliding stroke for the second structure on the first structure.

Preferably, provision is made for the side lugs of the second structure to be mounted on ends of the crossbar, outside the side branches of the first structure, and for the side lugs to be constrained to move in rotation with the crossbar and to be angularly indexed relative thereto.

Also preferably, the first structure is fitted with a common unlocking member functionally connected to the end hooks, said common unlocking member being arranged both to unlock the end hooks hooked on the standard anchor unit of the vehicle, and also to disengage the two pawls from their ratchets of catches, thereby allowing the second structure to slide in a direction opposite to the engagement direction. In particular, the common unlocking member is a U-shaped hinged lever having side branches hinged in the side branches of the first structure and passing through the slides of the second structure under the pawls associated with said slides, and having a central branch forming an operating handle arranged, in an inactive position, to engage on the side branches of the first structure, said operating handle being capable of being pulled manually from its inactive position to unlock the end hooks, and subsequently also to be pivoted so as to disengage the pawls from the associated ratchet.

It is also advantageous to make provision for the second structure to present a casing covering the two slides and the crossbar of said second structure.

Also preferably, each side lug of the second structure is fitted with engagement means arranged to receive and lock a fastener tab in one or the other of two opposite positions corresponding to mounting the seat structure facing forwards or facing backwards. In particular, the engagement means of each side lug are also arranged to expel the fastener tab when a pivoting locking hook is operated to separate the seat structure from the intermediate structure.

Finally, and advantageously, the seat structure that is fastened on the intermediate structure is a seat base onto which a seat shell is subsequently mounted, which shell can be disengaged separately from said seat base. In particular, the seat base is arranged to be fastened on the intermediate structure either facing forwards or facing backwards, and so as to hold the seat shell in place in both of those positions.

Other characteristics and advantages of the invention appear more clearly in the light of the following description and the accompanying drawings, relating to a particular embodiment.

### BRIEF DESCRIPTION OF THE DRAWINGS

Reference is made to the figures of the drawings, in which:

FIG. 1 is an exploded elevation view showing a seat structure for fastening on the intermediate structure (not shown), here in accordance with an arrangement comprising a seat base onto which a separate seat shell is subsequently mounted;

FIG. 2 is a perspective view showing the rear and the underside of the above-mentioned seat base, and in particular the fastener tabs used for fastening to the seat structure;

FIG. 3 is an elevation view showing the above-mentioned seat structure put into place on the intermediate structure, which intermediate structure is itself fastened on the standard anchor unit of the vehicle, in a forward-facing position;

FIG. 4 is a view analogous to that of FIG. 3, showing the rearward-facing position, the seat base being turned through 180° relative to the previous position and a support strut being deployed;

FIG. 5 is a perspective view showing the intermediate structure of the seat of the invention, a U-shaped bar forming part of the seat base structure, with two fastener tabs thereof being snap-fastened in the side lugs of the intermediate structure;

FIG. 6 is a perspective view analogous to that of FIG. 5, without the U-shaped bar of the seat base, and with an additional reinforcing bar as a variant;

FIG. 7 is a fragmentary detail view showing the arrangement of the ends of the crossbar on which the two side lugs are mounted;

FIGS. 8 and 9 are perspective views analogous to the view of FIG. 5, but without the protective casing, so as to show more clearly the components present, respectively in the pushed-back position and in the advanced position of the sliding portion of the intermediate structure, corresponding respectively to a position for putting the intermediate structure into place and a position for putting the seat structure finally into place on the intermediate structure;

FIGS. 10 and 11 are detail views respectively in perspective and in elevation, showing more clearly the structure of a slide fitted with a pawl, forming a portion of the sliding assembly of the above-specified intermediate structure, FIG. 11 showing manual unlocking both of the hooks for fastening to the standard anchor unit of the vehicle by pulling on an unlocking lever (position shown in chain-dotted lines), and of the pawls by pivoting the same unlocking lever (position shown in continuous lines);

FIGS. 12 and 13 are perspective views of a side lug, respectively in a position for locking the fastener tab (not shown) and in an open position ready to receive said fastener tab;

FIGS. 14 and 15 are elevation views of a side lug, respectively in the position for locking the fastener tab and in the position for releasing said fastener tab while unlocking; and

FIG. 16 is a diagrammatic view showing the steps of putting the seat structure fitted with the above-mentioned intermediate structure into place.

### DETAILED DESCRIPTION OF A PREFERRED EMBODIMENT

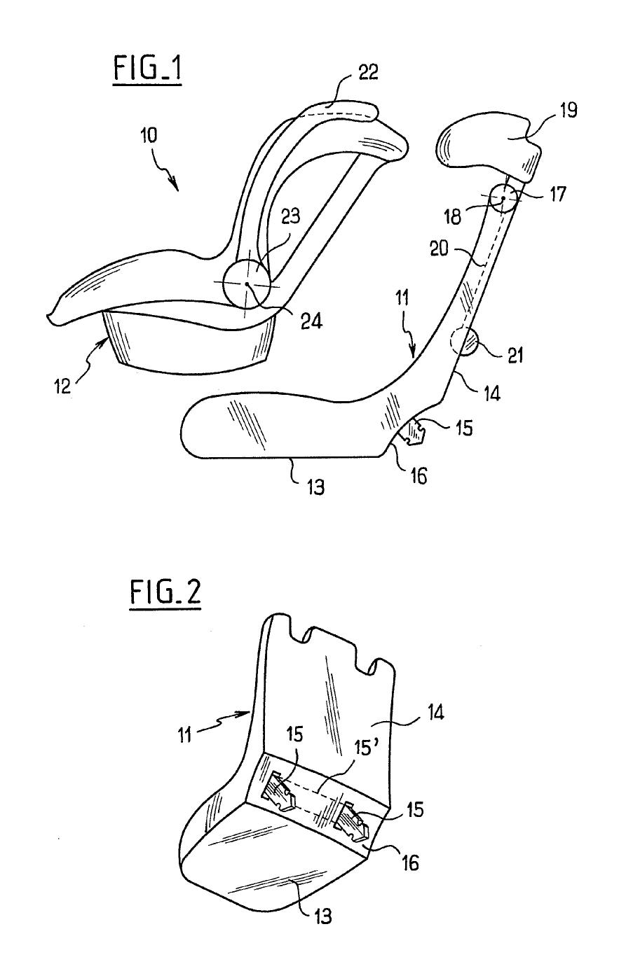

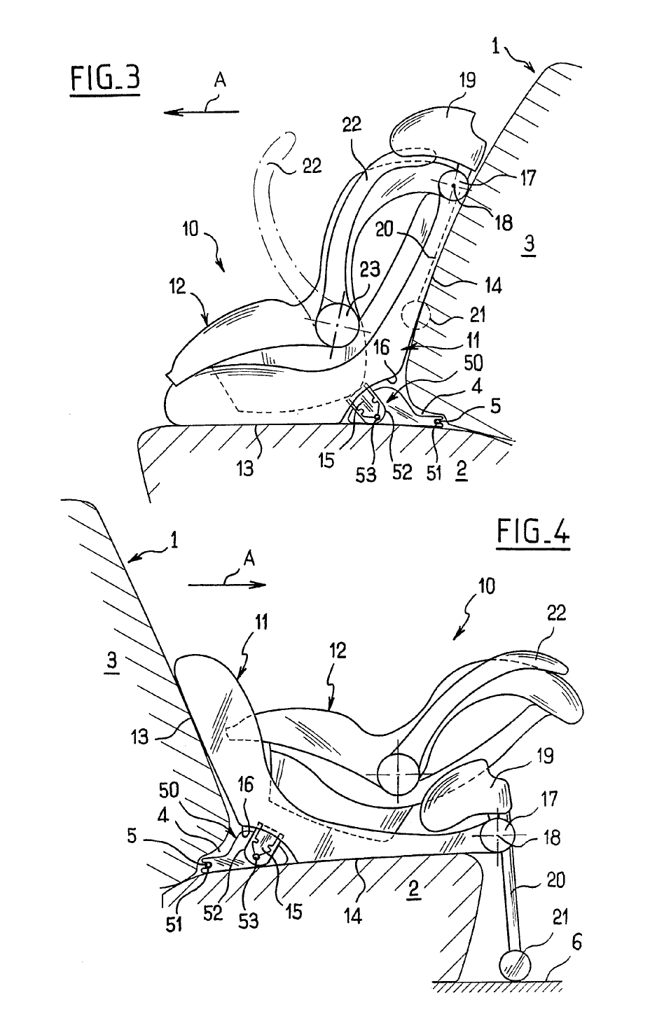

FIGS. 1 and 2 show a seat structure 10 for fastening on an intermediate structure for connection to the anchor unit of a vehicle, said seat structure in this example comprising a seat base 11 on which a seat shell 12 is mounted, which shell can be released separately from said seat base. The seat base 11 presents two bearing surfaces 13, 14 which, in the holding position, come into contact either with the seat cushion of the vehicle or with the seat back of said vehicle. The seat base 11 is provided with a fitting 15′ that is rigidly secured thereto, being generally U-shaped, and terminating in two side fastener tabs 15, each with a triangular tip and two notches. Provision is also made for a setback 16 in the vicinity of the fastener tabs 15 to make said tabs easier to view from the sides while they are being snap-fastened. The seat base 11 is also provided with a pivoting assembly 17, arranged to be capable of turning about a transverse axis 18, this assembly being secured at one side of the axis 18 to a padded projection 19, and on the other side of the axis 18 to a strut extension 20 that is terminated by a support foot 21. The seat shell 12 includes an arcuate handle assembly 22, connected to two side hubs 23 enabling said handle to be turned about a transverse axis 24.

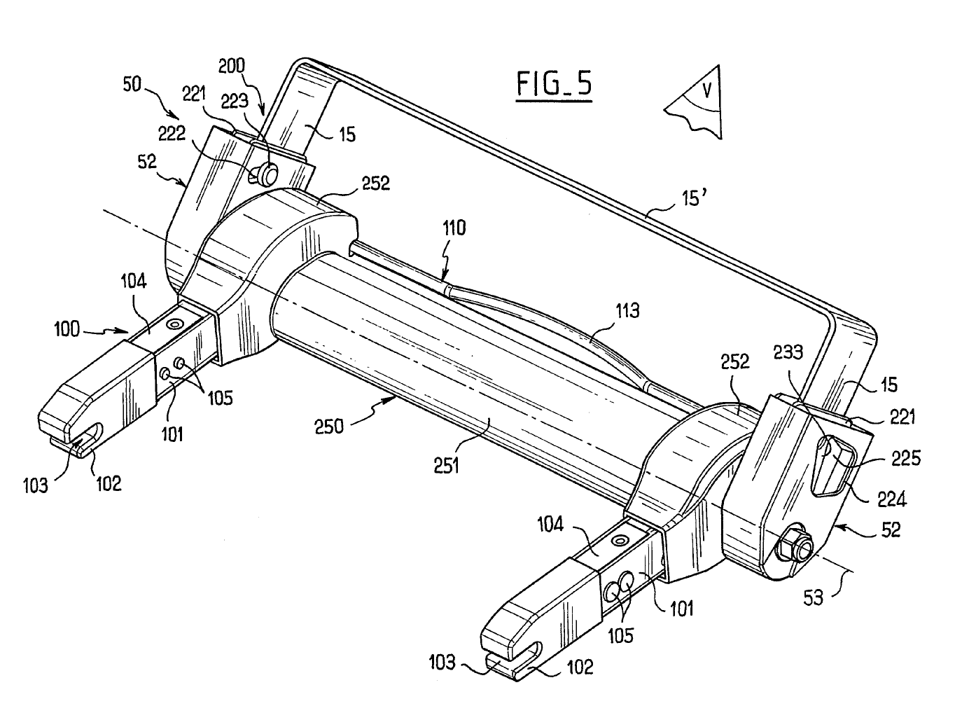

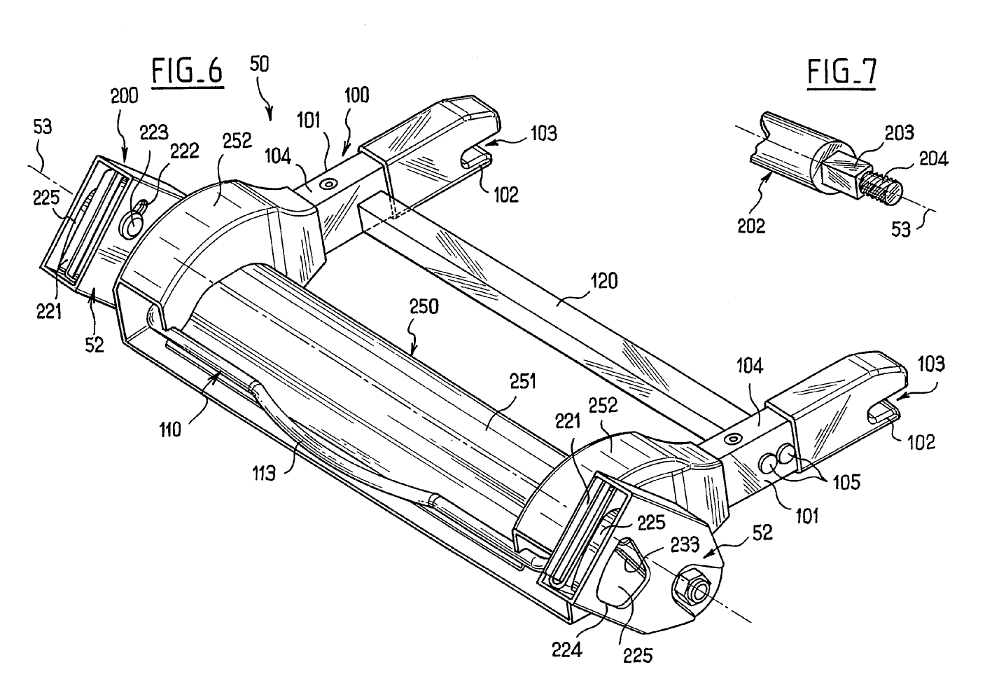

As can be seen in FIGS. 3 and 4, the seat base 11 can be mounted either facing forwards for a very young child (so-called “group 1” position), or else facing rearwards for a baby (so-called “group 0” position), relative to the forward direction A of the vehicle.

In FIG. 3, which is the forwardly-facing position, the bearing faces 13 and 14 of the seat base 11 come respectively into contact with a seat cushion 2 and with a seat back 3 forming part of the vehicle seat 1. In this position, the padded projection 19 acts as a headrest for the child that is installed in the seat shell 12, and the strut portion 20, 21 of the pivoting assembly is integrated in what constitutes the back of the base.

In contrast, in FIG. 4 which shows the rearwardly-facing position, it is the faces 14 and 13 of the seat base 11 that are in contact respectively with the seat cushion 2 and the seat back 3. In this position, the padded projection 19 has been pivoted through about 90°, and performs a function of wedging the seat shell 12, the portion of the extension 20, 21 constituting a support strut engaging the vehicle floor, referenced 6. This about-turn principle is already described in document EP-1 418 085 A1 in the name of the Applicant.

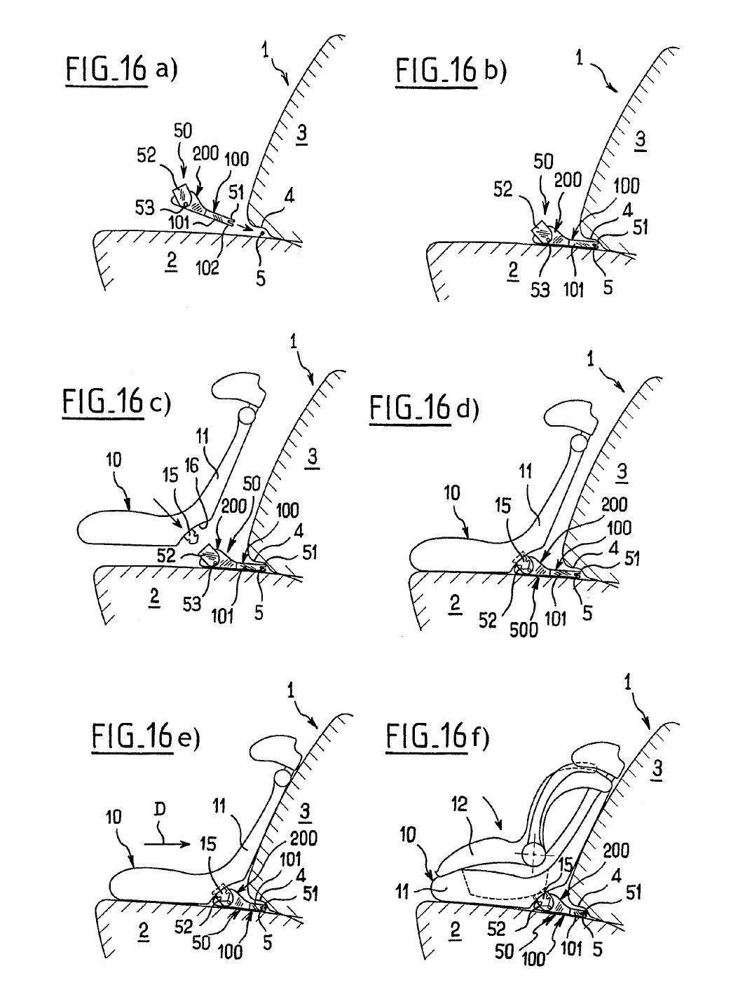

FIGS. 3 and 4 also show the presence of an intermediate structure 50 that is an independent structure providing the connection between the seat structure 10 and a standard anchor unit constituted in this example by transverse rods 5 associated with a space 4 in the vehicle seat 1. To the rear, the intermediate structure 50 thus presents end hooks 51 that are arranged to be capable of hooking in hinged manner on the standard anchor unit 5, while to the front, it presents hinged side lugs referenced 52 that receive the fastener tabs 51 secured to the seat structure 10. The fastener tabs 15 are snap-fastened in respective side lugs 52 and the seat structure, whatever its position relative to the road, is held firmly against the faces of the seat cushion and of the seat back of the vehicle. Reference 53 designates the transverse pivot axis for the side lugs 52, and it can be seen that this axis is at the same level, relative to the bearing face of the seat cushion 2, as the transverse axis corresponding to the standard anchor unit 5, i.e. level with the bearing face of the seat cushion 2. The intermediate structure 50 is shown in FIGS. 3 and 4 in highly diagrammatic manner, in particular without showing that said intermediate structure is itself arranged as two structures, one of which can slide relative to the other so as to enable the distance between the two hinge axes 5 and 53 to be modified. It is specifically this variable geometry of the intermediate structure 50 that serves to simplify considerably putting the seat structure into place, as can be seen more particularly in diagrammatic FIG. 16 as described further on below.

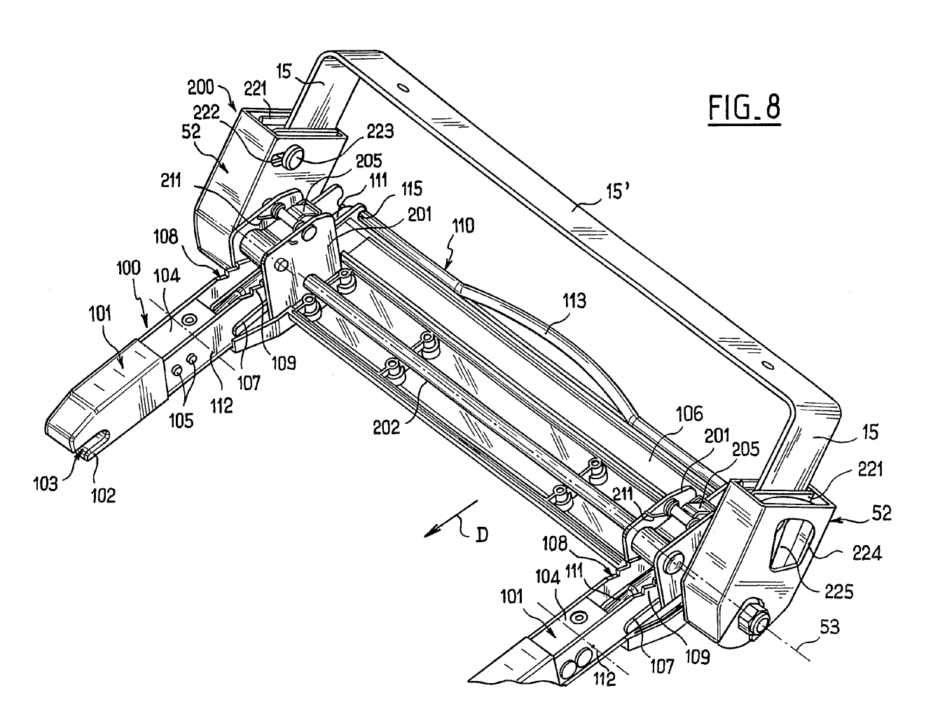

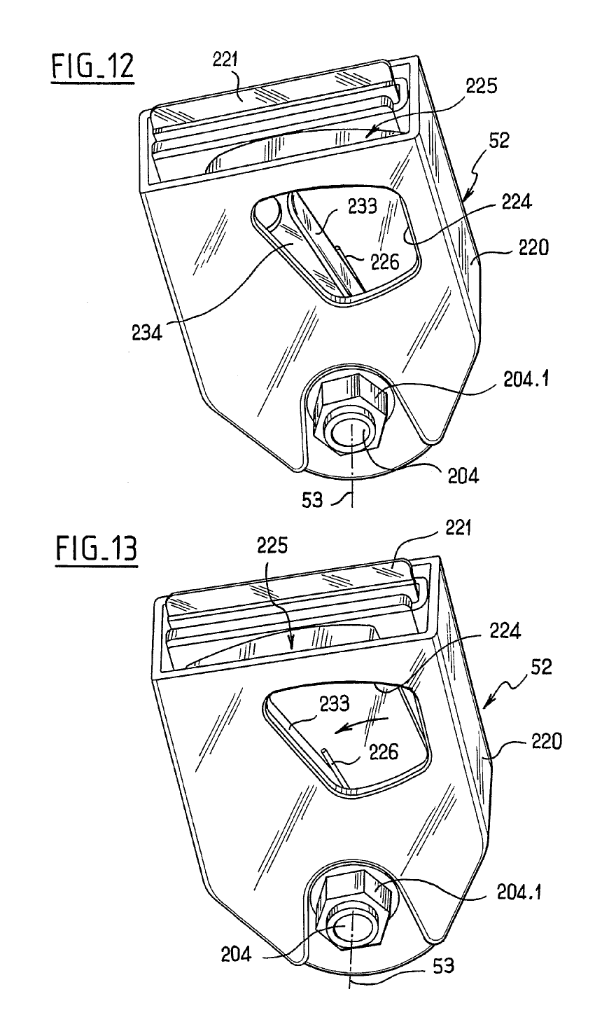

There follows a more detailed description of the components of the above-specified intermediate structure 50, with reference to FIGS. 5 to 15.

The intermediate structure 50, which is an independent structure, is made up firstly of a first structure 100 comprising, two parallel side branches 101, on either side of a vertical plane of symmetry V (identified solely in FIG. 5). These two side branches 101 are constituted by upwardly-open channel-section bars, and they are fitted with fastener means rigidly secured by rivets 105, forming a fastener clamp designed to enable fastening to the standard anchor unit of a vehicle. For this purpose, each branch end has a terminal nose 102 with an opening 103 having an end hook 51 (not shown in these figures) disposed therein. The end hooks 51 are thus arranged to permit hooking in hinged manner onto the standard anchor unit 5 of a vehicle.

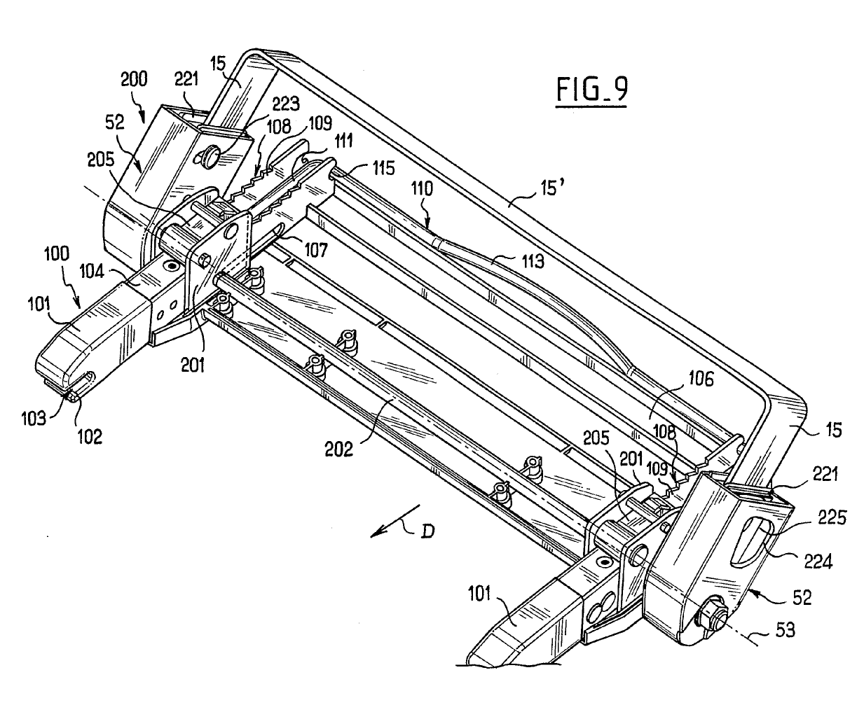

Specifically, the first structure 100 is generally U-shaped, with side branches 101 interconnected by a transverse branch 106 that ensures the assembly is rigid. Where necessary, and as shown in FIG. 6, provision can be made for an additional reinforcing cross-member 120 interconnecting the two side branches 101. Naturally, in a variant, a different arrangement could be provided for the transverse connection, in order to have an H-shape, or the like. It is also possible to provide a rigid arrangement in the form of a plate, with its side edges then constituting the “side branches” of the first structure, when arranged in this way.

The intermediate structure 50 also comprises a second structure referenced 200 that is mounted to slide on the side branches 101 of the first structure 100, being capable of being locked thereto in a plurality of axial positions. Fundamentally, the second structure 200 presents two side lugs on either side of the above-mentioned plane of symmetry V, which side lugs 52 are hinged about a common transverse axis 53 and are arranged for direct and separable snap-fastening with the fastener tabs 15 that are rigidly secured to the seat structure 10.

In FIGS. 5, 8, and 9, there can be seen the fastener bar 15′, which is rigidly secured to the seat structure 10, and which is terminated by two side branches 15 having free ends that are shaped to have tips with two notches so as to enable them to be snap-fastened into the side lugs 52.

The side branches 101 of the first structure 100 form rails on which sliders 201 of the second structure 200 are mounted, which sliders are interconnected by a crossbar 202 on the common axis 53 of the two side lugs 52 of said second structure. The side branches 101 of the first structure 100 include oblong slots 107 through which the crossbar 202 of the second structure 200 passes, said slots thus defining a sliding stroke for the second structure 200 on the first structure 100. As an indication, this sliding stroke may be of the order of 30 millimeters (mm) to 60 mm, for example.

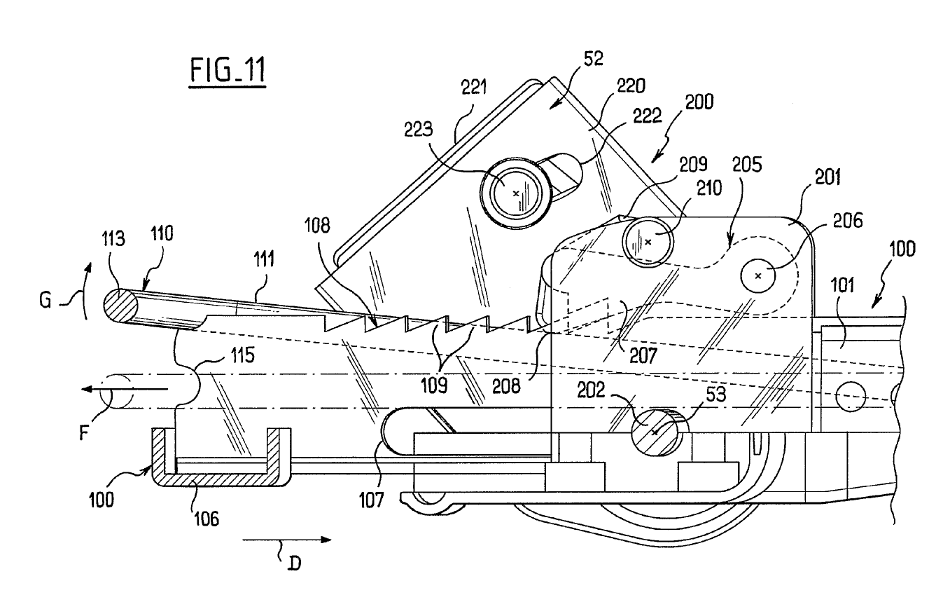

The second structure 200 can thus move between a pushed-back position (FIG. 8) in which the crossbar 202 is remote from the transverse axis passing via the end hook 51, and an advanced position in which the crossbar 202, which is moved sideways relative to its axis, comes closer to the transverse axis of the end hooks 51. This thus provides a genuinely variable geometry for the intermediate structure 50, enabling the anchor points for the fastener tabs of the seat structure 10 to be moved closer to or further from the back of the vehicle seat.

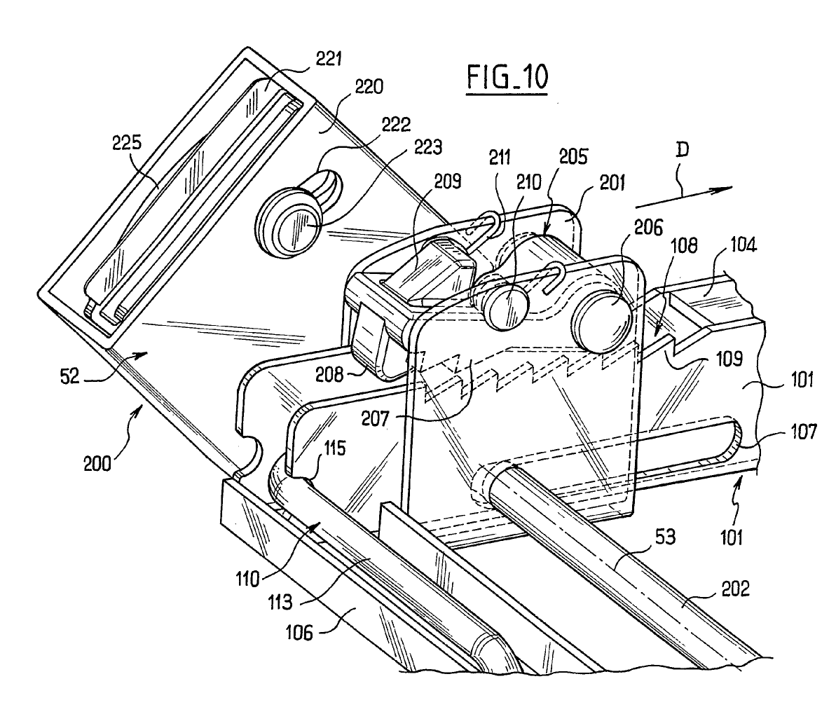

Specifically, the side lugs 52 of the second structure 20 are mounted on ends of the crossbar 202, outside the side branches 101 of the first structure 100. As shown in the detail of FIG. 7, each end of the crossbar 202 presents a square 203 that is extended by a threaded end 204. The square portion provides coupling in rotation with the side lug 52 via a complementary square opening formed in said side lug. Clamping is completed by a nut 204.1 which is screwed onto the threaded end 204. Thus, the side lugs 52 are constrained to turn with the crossbar 202 and they are angularly indexed relative thereto. This ensures accurate positioning of each side lug 52 relative to the other, thus avoiding any risk of jamming while the fastener tabs 15 are being put into place relative to the side lugs.

There follows a description of the means enabling the second structure 200 to be locked to the side branches 101 of the first structure 100 in a plurality of axial positions.

Each side branch 101 of the first structure 100 thus presents a ratchet 108 of sawtooth-shaped catches 109. Specifically, since the side branches 101 are made in the form of channel section bars, the ratchet 108 is provided in both of the free edges of the flanges of the channel section. Furthermore, each slider 201 of the second structure 200 has a pawl 205 mounted to pivot about a transverse axis 206 parallel to the crossbar 202. The pawl 205 presents downwardly-facing teeth 207 adapted to co-operate with the catches 109 of the ratchet 108. The pawl 205 is urged against the ratchet 108 by a hairpin spring 211 mounted on a transverse rivet 210. The pawl 205 presents a bottom portion 208 and a top portion 209 giving it a hook-shape. The top portion 209 co-operates with the rivet 210 to define a maximally-raised position for the pawl 205. The pawl 205 is thus pivotally movable between an engaged position and a disengaged position. An engaged position is possible with each of the catches 109, thus giving a set of six different axial positions in this example, where the number of positions could naturally vary, in particular as a function of the desired axial stroke. Reference D designates the engagement direction corresponding to moving each slider 201 towards the associated end hook 51 of the side branch 101 of the first structure 100. The second structure 200 can thus slide freely in the direction D, merely by exerting thrust on said second structure, which requires very little effort. It is this movement that occurs when the intermediate structure 50 has already been hooked to the standard anchor unit of the vehicle, with the intermediate structure resting on the cushion of the vehicle seat, and with the seat structure positioned to be engaged with the side lugs of the intermediate structure. By pushing on the seat structure, the moving structure 200 moves in translation towards the seat back, until the seat structure comes to bear against said seat back.

In a variant (not shown), it is possible to arrange the parallel ratchets 108 on the second structure 200, with the associated pawls 205 being arranged on the first structure 100.

It must also be possible to move the second structure 200 backwards, and thus to release the pawls 205 from their ratchets 108. For this purpose, the first structure 100 is fitted with a common manual unlocking member 110 arranged to disengage both pawls 205 from their ratchets 108 having catches, thereby enabling the second structure 200 to slide in the opposite direction to the engagement direction D.

Specifically, the common unlocking member 110 is a U-shaped hinged lever, having its side branches 111 hinged about an axis 112 in the side branches 101 of the first structure 100, and passing through the slides 201 of the second structure 200 under the pawls 205 associated with said slides. The side branches 111 of the unlocking lever 110 are functionally connected to the respective end hooks 51 so as to open said hooks when the side branches are pulled away in the direction opposite to the direction D. The connection zone is not visible in the figure, because of the presence of a cover plate 104. The unlocking lever 110 has a central branch 113 that forms an operating handle. When in an inactive position (as shown in FIGS. 8 to 10), this central branch 113 is arranged to engage on the side branches 101 of the first structure 100. This engagement is obtained via notches 115 formed in the rear edges of the side branches 101.

Thus, the unlocking lever 110 can be pulled manually away from its inactive position by means of its handle 113 in order to unlock the end hooks 51 that are hooked onto the anchor unit of the vehicle, and it can also be pivoted in order to disengage the pawls 205 from their ratchets 108 by the side branches 111 coming into contact with the bottom portions 208 of the pawls 205, which pawls are then raised and disengage from the associated ratchets 108, thereby releasing the corresponding connection, and then allowing the second structure 200 to be moved back in a direction opposite to the engagement direction D. Co-operation between the common unlocking U-shaped hinged lever 110 and the two pawls 205 can be better understood with reference to the view shown in FIG. 11. FIG. 11 shows the unlocking lever 110 being moved by exerting manual traction in a direction F (opposite to the direction D), which movement unlocks the end hooks 51 that are hooked to the anchor unit of the vehicle, and the figure also shows subsequent pivoting of said lever in a direction G, which pivoting disengages the pawls 205 from their associated ratchets 108. It should be observed that the notches 115 provide rigid and stable blocking for the unlocking lever 110, and that the handle of said lever is not accessible when the seat structure is in place, so as to avoid any accidental or untimely operation, thereby ensuring completely safe locking relative to the anchor unit of the vehicle.

As can be seen better in FIGS. 5 and 6, the second structure 200 presents a casing 250 enclosing the two slides 201 and the crossbar 202 of said second structure. For this purpose, the casing 250 has a central portion 251 surrounding the crossbar 202, and two side portions 252 covering the slide 201 and their pawls 205, so as to cover the square or rectangular profiles of the side branches 101 of the first structure 100. This casing serves to avoid any risk of pinching or injury when putting the safety seat into place or when removing it.

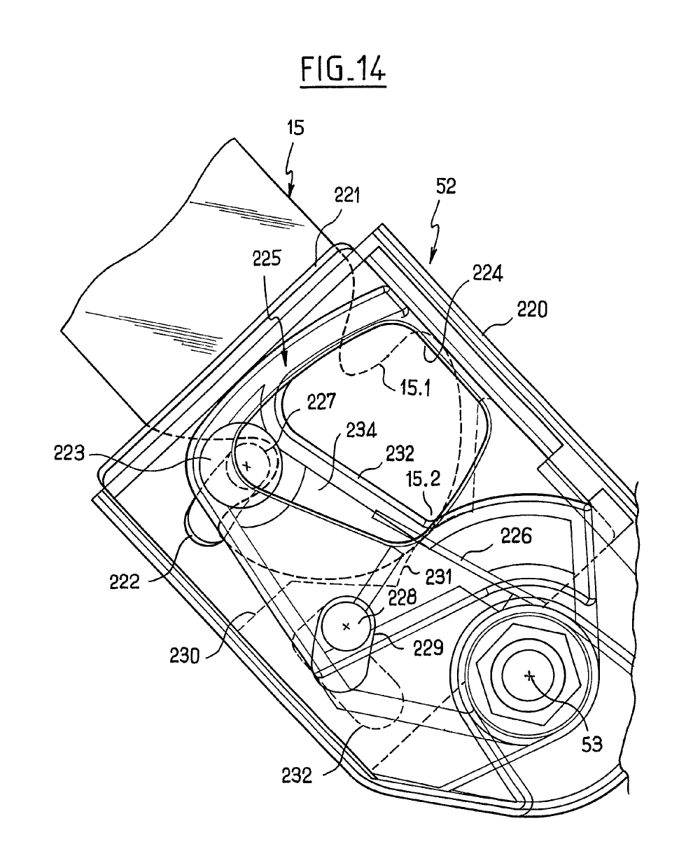

The structure of the side lugs 52 of the second structure 200 is described in greater detail below with reference to FIGS. 12 to 15.

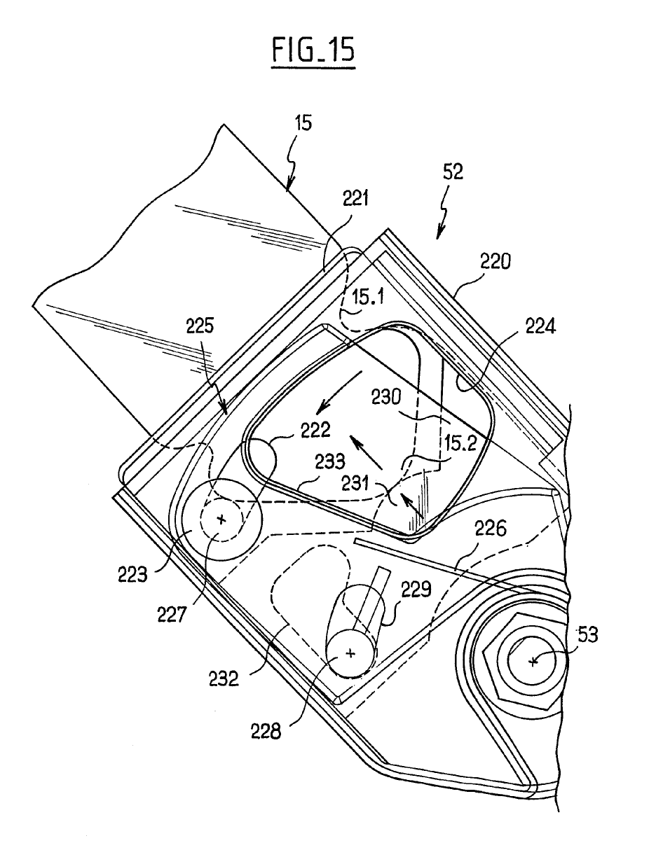

Each lug 52 comprises a box 220 containing folded plate 221 defining an insertion passage for the fastener tab 15 of the seat structure, the folded plate presenting top edges that are flared to facilitate guidance and insertion into the slot they define. There also be seen a hook 225 mounted to pivot about the axis 53 of the side lug, said hook being urged into a locking position that corresponds to the positions shown in FIGS. 12 and 14 by one branch of a torsion spring 226 mounted about the axis 53. To cause the hook 225 to pass into an unlocking position, each hook 225 is provided with an actuator rim 233 that is accessible via a side opening 224 in the box 220.

The hook 225 is also provided in its top portion with a closure rivet 223 having its shank 227 passing through a curved slot 222 provided in the box 220. The hook 225 also presents a transverse finger 228, closer to the axis 53, that passes through a curved slot 229 formed in the folded plate 221.

A sliding plate 230 is also provided that is mounted to be capable of moving in the box 220 towards or away from the axis 53. This plate 230 has a rounded top edge 231 for co-operating with the free end 15.2 of the fastener tab 15, and it also presents an L-shaped slot 232 through which the finger 228 of the hook 225 passes.

In the locked position, as shown in FIGS. 12 and 14, a notch 15.1 in the fastener tab 15 is held by the shank 227 of the closure rivet 223. This guarantees that the fastener tab 15 is securely engaged in the side lug 52. This engagement is held reliably by the action exerted by the spring 226 tending to hold the hook 225 in said position. The free end 15.2 of the fastener tab 15 is in contact with the edge 231 of the plate 230. In this position, the shank 227 of the closure rivet 223 is located at that end of the slot 222 that is closest to the midplane, containing the axis 53, and the finger 228 that passes through the slots 229 and 232 serves to hold the plate 230 in position. This provides good slack-free retention of the fastener tab 15 in the side lug 52. In this position, it is advantageous to provide a bright color on the zone 234 that lies beyond the operating rim 233 and that is therefore visible from the outside via the opening 224, as shown in FIG. 12. This visual verification of the colored zone makes it possible to ensure immediately that each fastener tab 15 is properly engaged in the associated side lug 52. When the operator acts with both thumbs on the operating portions 233 of the hooks 225, the hooks 225 are caused to tilt so as to release the shanks 227 from the corresponding notches 15.1, against the action of the springs 226. This moves to the unlocking position as shown in FIGS. 13 and 15. The shanks 227 of the closure rivets 223 then pass through the other end of the curved slots 222. The fingers 228 are also moved to the other ends of the L-shaped slots 229, thus enabling the other branches of the L-shaped slots 232 to be released, and consequently allowing the sliding plates 230 to move under the action of the springs 226. The rising of the plates 230 thus enables expulsion thrust to be exerted on the free edges 15.2 of the fastener tabs 15, thereby further facilitating removal of the seat structure.

Thus, each side lug 52 is fitted with engagement means that are both arranged to receive and lock a fastener tab 15 in one or other of two opposite positions corresponding to mounting the seat structure 10 facing forwards or facing rearwards, and also arranged to expel the fastener tab 15 when the pivoting locking hook 225 is moved to separate the seat structure 11 from the intermediate structure 50.

There follows a description of the steps involved in putting the safety seat 10 into place, this description being given with reference to the diagrams of FIG. 16:

a) the intermediate structure 50 is handled on its own, being brought up to the zone of the standard anchor unit in the vehicle until its ends 102 come up to said anchor unit so as to hook the hooks 51 onto the rods of the anchor unit 5, with this operation being performed easily, not only because of the light weight of the intermediate structure 50, but also because of the large field of view that leaves the vehicle anchor unit 5 perfectly visible;

b) the intermediate structure 50 is now securely engaged on the standard anchor unit 5, and the intermediate structure rests on the support surface of the seat cushion 2;

c) the seat structure proper, i.e. specifically the seat base 11, is brought up so that its fastener tabs 15 come up to the insertion slots in the side lugs 52, and these fastener tabs 15 are pushed into the side lugs 52 until they become engaged by snap-fastening, this operation being performed very easily insofar as the field of view around the anchor zone for the fastener tabs 15 is not impeded in any way by the presence of the seat back 3 (the field of view seen sideways is already satisfactory because of the setback 16, but provision may also optionally be made for a window in the seat base so as to have a direct face view of the fastener tabs 15, in order to make it even easier to bring them up to the side lugs 15);

d) the seat base 11 is now securely engaged on the intermediate structure 50, and said seat base rests naturally on the seat cushion 2 of the vehicle;

e) it then suffices to exert thrust on the seat assembly 10 in order to cause the second structure 200 to move relative to the first structure 100, sliding in the engagement direction D, so as to bring the rear face of the seat assembly up to the seat back 3, this movement continuing until contact is made with the seat back, the second structure 200 then being engaged on the first structure 100 in such a manner as to ensure that it is securely locked in the final position as shown; and

f) with the seat base 11 securely in position, it is then possible to place the seat shell 12 thereon.

When it is desired to remove the seat assembly 10, it suffices to disengage the seat shell 12 from the seat base 11, and then to operate the hooks 225 so as to unlock the fastener tabs 15, thereby disengaging the seat assembly 10 from the intermediate structure 50. It should be observed that the intermediate structure 50 can then be left in place, or else it can itself be disengaged for putting away, by pulling on the unlocking lever 110 which is then accessible because the seat base 11 has been removed.

Subsequently, when it is desired to put the seat assembly back into place, the intermediate structure 50 needs to be reinitialized by raising the unlocking lever 110, and by moving the second structure 200 backwards relative to the first structure 100, so as to return to the position shown in b).

As can readily be understood, the operations described with reference to FIG. 16 can be performed regardless of the orientation of the seat base, such that it can be mounted equally easily facing forwards or backwards.

Naturally, the invention is not limited in any way to a seat assembly presenting a seat base and a seat shell that are separate, and it would be equally possible to provide a conventional one-piece seat assembly, which would then be engaged directly on the side lugs in the manner described above.

The invention is not limited to the embodiments shown above, but on the contrary covers any variant using equivalent means to reproduce the essential characteristics specified above.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A safety seat for installing a baby or a very young child on a vehicle seat, the safety seat comprising both a seat structure for resting on a seat cushion of a vehicle and for bearing against a seat back of said vehicle, and an intermediate structure for providing the connection between the seat structure and a standard anchor unit associated with the vehicle seat, said intermediate structure being an independent structure that is itself made up both of a first structure comprising, on either side of a vertical plane of symmetry, two parallel side branches terminating in end hooks arranged to be capable of hooking in hinged manner on a standard anchor unit of a vehicle, and of a second structure mounted to slide on the side branches of the first structure, being capable of being locked thereon in a plurality of axial positions, said second structure including, on either side of said plane of symmetry, elements arranged to enable direct or separable snap-fastening engagement of two fastener tabs that are secured to the seat structure, wherein said elements for direct and separable snap-fastening engagement of the fastener tabs associated with the seat structure are side lugs hinged about a common transverse axis, and wherein one of the first structure and the second structure present two parallel ratchets of catches with which respective pawls co-operate that are urged against said ratchets by respective associated resilient members, said pawls being carried by the other one of said first structure and of said second structure, the mutual engagement direction corresponding to the second structure moving towards the end hooks of the side branches of the first structure, and the catches of said ratchets define the plurality of axial positions for locking the second structure on said side branches of the first structure.

2. The safety seat according to claim 1, wherein the first structure is generally U-shaped with side branches forming rails on which slides of the second structure are mounted, the slides being interconnected by a crossbar on the axis common to the two side lugs of said second structure.

3. The safety seat according to claim 2, wherein the ratchets of catches are carried by the side branches of the first structure, and the pawls associated with said ratchets are carried by the slides of the second structure.

4. The safety seat according to claim 2, wherein the side branches of the first structure include oblong slots through which the crossbar of the second structure passes, said slots thus defining a sliding stroke for the second structure on the first structure.

5. The safety seat according to claim 2, wherein the side lugs of the second structure are mounted on ends of the crossbar, outside the side branches of the first structure.

6. The safety seat according to claim 5, wherein the side lugs are constrained to move in rotation with the crossbar and are angularly indexed relative thereto.

7. The safety seat according to claim 1, wherein the first structure is fitted with a common unlocking member functionally connected to the end hooks, said common unlocking member being arranged both to unlock the end hooks hooked on the standard anchor unit of the vehicle, and also to disengage the two pawls from their ratchets of catches, thereby allowing the second structure to slide in a direction opposite to the engagement direction.

8. The safety seat according to claim 7, wherein the common unlocking member is a U-shaped hinged lever having side branches hinged in the side branches of the first structure and passing through the slides of the second structure under the pawls associated with said slides, and having a central branch forming an operating handle arranged, in an inactive position, to engage on the side branches of the first structure, said operating handle being capable of being pulled manually from its inactive position to unlock the end hooks, and subsequently also to be pivoted so as to disengage the pawls from the associated ratchet.

9. The safety seat according to claim 2, wherein the second structure presents a casing covering the two slides and the crossbar of said second structure.

10. The safety seat according to claim 2, wherein each side lug of the second structure is fitted with engagement means arranged to receive and lock a fastener tab in one or the other of two opposite positions corresponding to mounting the seat structure facing forwards or facing backyards.

11. The safety seat according to claim 10, wherein the engagement means of each side lug are also arranged to expel the fastener tab when a pivoting locking hook is operated to separate the seat structure from the intermediate structure.

12. The safety seat according to claim 1, wherein the seat structure that is fastened on the intermediate structure is a seat base onto which a seat shell is subsequently mounted, which shell can be disengaged separately from said seat base.

13. The safety seat according to claim 12, wherein the seat base is arranged to be fastened on the intermediate structure either facing forwards or facing backwards, and so as to hold the seat shell in place in both of those positions.
